(19) United States
(12) Patent Application Publication
(10) Pub. No.: US 2014/0279906 A1
(43) Pub. Date: Sep. 18, 2014

(54) APPARATUS, SYSTEM AND METHOD FOR MULTIPLE SOURCE DISAMBIGUATION OF SOCIAL MEDIA COMMUNICATIONS

(71) Applicant: Bart Michael Peintner, Palo Alto, CA (US)

(72) Inventor: Bart Michael Peintner, Palo Alto, CA (US)

(21) Appl. No.: 13/802,327

(22) Filed: Mar. 13, 2013

(51) Int. Cl. G06F 17/30

(52) U.S. Cl. CPC G06F 17/3053
USPC 707/639

(57) ABSTRACT

The present invention is directed to a system for understanding social media. The system may provide automated machine understanding of social media communications based on: social media assertions, social media statements and conversations, social connections, user profile info, crowd-sourced databases, Internet pages, and semantic networks.

### FIELD OF THE INVENTION

The present invention generally relates to an apparatus, system, and method for understanding communications between users of Internet based social media. More particularly, this invention relates to an apparatus, system, and method for collecting communications exchanged by users of Internet based social media, determining the entities (e.g., people, places, organizations, media, and fictional characters) that are referenced in those communications, determining the author's sentiment about those entities (e.g., love, hate, and indifference), and extracting the author's interests into an inferred user profile, which may be stored in a research database for use in targeted marketing of goods and services.

### BACKGROUND

Automated machine understanding of social media has value because social media statements and actions may reveal the interests, opinions, and personality of the author. Significant technical challenges, however, may exist for understanding social data posts. For example, social data posts may incorporate shorthand notations for entities (e.g., MJ, instead of Michael Jordan) that are discussed in the communication. Social media posts, further, may include poor grammar, slang, and clever or lazy turns of phrase. Accordingly, a need exists for systems and methods for automated machine understanding of social media communications, which incorporate semantic inferences and syntactic analyses to identify and analyze social media statements and actions.

### SUMMARY

Hence, the present invention is directed to a computer-implemented method performed by a processor for understanding a snapshot of social network information. The method may include accessing social network information associated with a user of social media, collecting a snapshot of social network information associated with the user which comprises a plurality of social media statements, accessing a plurality of subculture models, and analyzing the snapshot of social network information and the plurality of subculture models to identify a weighted set of subcultures that reflects interests of the user. The method may further include analyzing the snapshot of social network information to identify one or more contacts associated with the user, assigning a weight to each contact that reflects the strength of each contact's connection to the user, and generating a personalized language model for the user that is based on the weighted set of subcultures and the set of contacts associated with the user. The personalized language model may include an entity list.

Additionally, the method may include extracting at least one mention of entities that are identified on the entity list from the plurality of social media statements, compiling a list of possible references for the at least one mention of entities extracted from the plurality of social media statements, inferring a weighted posterior distribution over the list of possible references for the at least one mention of entities that are identified on the entity list; and analyzing the weighted posterior distribution to identify a list of disambiguated references for the at least one mention of entities in the snapshot of social network information.

In one aspect, the method may include rating the user's sentiment for the list of disambiguated references and recording the user's sentiment for the list of disambiguated references in a database of inferred user profile opinions. Rating the user's sentiment for the list of disambiguated references may include word-based targeted sentiment analysis and pattern-based targeted sentiment analysis. Pattern-based targeted sentiment analysis may include comparing at least one of the user's plurality of social media statements with a pattern of expressions. The pattern of expressions may include a regular expression, a rating, and a confidence value.

In another aspect, the method may include inferring an updated weighted set of subcultures that reflect interests of the user based on an analysis of the snapshot of social media and the list of disambiguated references. The method may include recording the updated weighted set of subcultures that reflect interests of the user in a database of inferred user profile interests.

In another aspect, the method may include recording the updated weighted set of subcultures that reflect interests of the user in a database of inferred user profile interests.

In another aspect, the plurality of subculture models each may include a database of subculture specific entities and a database of subculture specific entity nicknames. Each of the plurality of subculture models further may include a database of subculture specific sentiment patterns. Also, each of the plurality of subculture models further may include a database of subculture specific semantic graph connections. Further still, each of the plurality of subculture models may include a database of subculture specific weighted N-grams. Each of the plurality of subculture models further may include a database of subculture specific co-occurrence frequencies.

### DESCRIPTION OF THE DRAWINGS

The accompanying drawings, which are incorporated herein and constitute part of this specification, illustrate an embodiment of the present invention, and together with the general description given above and the detailed description given below, serve to explain aspects and features of the present invention.

FIG. 1 is a block diagram of an exemplary system for understanding social media in accordance with the present invention;

FIG. 2 is a process flow chart for the system of FIG. 1;

FIG. 3 is a block diagram for generating a subculture model for the system of FIG. 1;

FIG. 4 is a process flow chart for the entity disambiguation process for the system of FIG. 1;

FIG. 4a is a concept map of an entity disambiguation method of the present invention.

FIG. 5 shows an illustrative semantic network generated by the process of FIG. 4.

FIG. 6 shows two semantic paths for a first combination of entities in the semantic network of FIG. 5;

FIG. 7 shows another semantic path for a second combination of entities in the semantic network of FIG. 5;

FIG. 8 is a schematic diagram of a computer system for implementing the system of FIG. 1.

### DESCRIPTION

FIG. 1 depicts an exemplary system 100 for understanding social media in accordance with the present invention. The exemplary system 100 may provide automated machine understanding of social media communications based on the following inputs: social media assertions (e.g., Facebook Like or Pin on Pinterest), 101; social media statements and conversations (e.g. Twitter Tweets or Facebook Posts and Comments), 102; social connections (e.g., Facebook friends or Twitter followers), 103; user profile info (e.g., family, jobs, location from social networks), 104; crowd-sourced databases and freely available internet pages (e.g., wikipedia, productwiki, public calendars), 105; and semantic networks, which may be hand-crafted or extracted from open source repositories, 106.

These inputs, along with subculture models (112), which may be generated offline from the same inputs, pass through the Social Media Understanding Engine (SMUE) 107, which extracts evidence of the social media user's personality 108, interests 109, opinions 110 and product relationships 111, and records this information in a repository of inferred user profiles.

In the system of FIG. 1, understanding social media statements may be defined as follows:
determining which entities are referenced (including people, places, organizations, media (e.g., movies), fictional characters);
determining the author's sentiment about those entities (love, hate, indifference); and
extracting the interests, subcultures, and knowledge bases of the author.
   Additionally, processing a single snapshot of a person's social data may be defined as an understanding session. Subsequent understanding sessions may be conducted for each user, as more data is gathered.

The system of FIG. 1, leverages the notion of subcultures to understand social media. More particularly, the system may use a set of modeled subcultures to characterize the interests and knowledge base of social media users. Additionally, a set of modeled subcultures may provide context for understanding ambiguous statements made by social media users.

The usefulness of subculture identification and analysis in understanding social media statements may be demonstrated by evaluating the following illustrative social media statement, which may be found in a social media post: “I love watching anthony and bryant fight it out.” The entities in this statement, mentioned as “anthony” and “bryant” are ambiguous. The author knows which entities are referenced and presumes that the communications audience does too. For instance, the author may presume his audience knows which entities are referenced because (1) he knows the knowledge bases of his intended audience (at least to some extent); (2) he presumes that there are no other pair of entities that match the two mentions besides his intended references; or (3) some other element of the shared context (e.g., recent events), heavily favors his intended references.

For instance, if the author is a fan of NBA basketball (i.e., in the NBA subculture) and posts often about the NBA, the entities are most likely Carmelo Anthony and Kobe Bryant, two of the top players in that league, and therefore two commonly referenced entities by those in that subculture. If the two players played against each other in the past 24 hrs, the likelihood of this conclusion is raised. By contrast, if the author is a mother of a son named Anthony and is not a fan of basketball, then “anthony” likely refers to her son. Similarly, given the “fight it out” clause, an author who is a fan of boxing would likely be referring to two boxers in a recent match. Finally, the “I love” clause indicates that the author is either a fan of the entities or a fan of the activity engaged by the entity.

Accordingly, social media understanding may be aided by subculture analysis because a subculture may generally reflect the language, customs and practices of a group of social media users that are connected by a common trait or interest.

In the context of FIG. 1, therefore, a subculture may be a group of social media users connected by a common trait or interest. A subculture may be modeled with the following exemplary criteria:
entities, entity nicknames, and their respective frequency of use;
a semantic graph connecting concepts used by the subculture;
co-occurrence statistics which describe how often two entities or concepts are mentioned together by a member of that subculture;
N-grams or common phrases used by members of that subculture, along with their respective frequency of use; and
sentiment patterns which reflect specific ways members of that subculture express positive or negative feelings toward entities.

Although the subculture models of FIG. 1 may be modeled using the foregoing parameters and measures, other parameter combinations may be used to model a subculture provided that another set of parameters measurably reflects the language, customs and practices of the group of users connected by the targeted common trait or interest.

FIG. 3 depicts elements of an exemplary subculture model, the data sources for the elements, and the processes that are used to extract and store the relevant data from each data source. Elements of the subculture model of FIG. 3 represent databases for storing relevant data. Subculture element models may be created as follows:
Entities 303, entity nicknames 306, and respective frequencies. Compare the frequency of entities found in subculture specific data sources with those in generic data. Both specific and general data can be found in crowd-sourced data 301 and public social network data 307, where Twitter is one example. Include an entity in the subculture if frequency ratio is very high. The Entity Extractor 302 may use extractor techniques 302 such as Pointwise Mutual Information (PMI) and Term Frequency-Inverse document frequency (TF-IDF) to extract entities 303 that are specific to the subculture. Explicit nickname lists (often found in crowd-sourced DBs 301 and special webpages 304) and standard natural language programming (NLP) techniques 305 may be used to extract nicknames for entities 306.
Semantic graph connecting the concepts used by the subculture 310. Existing data that connects semantic objects and concepts to phrases may be used to semi-automatically extract (308) a concept frequency table from the data. When ratio of subculture-specific frequencies to general data frequencies are high, include the semantic object in the subculture. For all extracted objects, pull the links between those objects from existing open source semantic ontologies 309. In addition, each semantic object may be manually annotated with a number, range 0 to 1, which indicates co-ocurrence surprise (defined below).
Co-occurrence statistics 313: If subculture-specific text 311 exists, compute 312 how often two entities or concepts are mentioned together by a member of that subculture.
Weighted N-grams 316: Compare 315 the frequency of phrases found in subculture specific data sources 311 with those in generic data 314 from corresponding sources. Include a phrase in the subculture if frequency ratio is very high.
Sentiment patterns 318: Manually extract 317 linguistic schemas that define specific ways members of that subculture express positive or negative feelings toward entities. These patterns may contain a tag for the entity, placeholders for word lists or word categories, and wildcards for filler words. For example, “I am a huge, loyal Raiders fan” could match the pattern “[Person designator] [Positive verb phrase] [0-2 adjectives] ENTITY [“fan”|“supporter”|“nut”]”. These manually extracted patterns may be automatically verified using labeled data.

Many of the methods described above involve comparing subculture-specific data with generic data, then comparing frequencies. Variants of existing techniques such as Pointwise Mutual Information (PMI) and Term Frequency-Inverse document frequency (TF-IDF) may be used for this purpose.

In view of the above, an exemplary subculture may be modeled by locating available data sources used predominately or exclusively by its members or representatives and then extracting and analyzing data associated with each element model. The element models may be improved by comparing the subculture-specific data sources with large data sources known to have only trace amounts of data for that subculture. For instance, models for an NBA basketball subculture can be extracted from NBA.com, win ipedia articles containing “NBA” within category names, twitter accounts devoted to the NBA, and other websites. To determine which elements of the data source are NBA specific, we cross reference the data with a similar, but distinct source, such as subculture data specific to another sport, and with general data, such as a sampling of wikipedia pages that do not contain NBA as a category. Thus, subculture modeling may attempt to leverage information considered pertinent to a particular topic (or fields of study) and which may be strongly associated with the knowledge base of individuals that are active in this area of interest.

FIG. 2 shows a process flow chart for understanding the social media contents for a single user. The SMUE may perform steps 1, 2, 3, and 6 once in a given understanding session; whereas, steps 4 and 5, may be repeated for each collected conversation or assertion made by the user:
1. Subculture identification 202: Process all social media assertions, social media statements and conversations, and user profiles to identify a weighted set of subcultures.
2. Personal entity extraction 203: Process all social connections, social media assertions, social media statements and conversations, and user profiles to determine the set of individuals known by the user, including friends, family, celebrities, and more. Assign a weight to each entity that reflects the relative strength of the connection.
3. Personal Language model generation 204: Generate a personalized language model for the user based on a weighted combination of the subculture models, the general model common to all users, and the user's personal entity lists.
4. Entity disambiguation: For each social media assertion, statement, and conversation, extract all mentions of entities 205, compile a list of possible references for each mention 206, and infer a weighted posterior distribution over the list of possible references for each mention 207. This distribution is used to disambiguate the mention or mark it as “unknown.”
5. Sentiment analysis 208: For all assertions, statements, and conversations that have clear matches between mentions and referenced entities, determine the author's sentiment for each referenced entity.
6. Evidence aggregation 210: For all referenced entities with positive or negative sentiment, combine the evidence into a single numerical expression of the author's sentiment toward referenced entities.

Subculture Identification.

This sub-process involves associating a weighted set of subcultures to a user of social media based on an analysis of a snapshot of the user's social media data. The process generates a score for each subculture based on the social media assertions, social media statements and conversations, and user profile. The score may be aggregation of subscores, each of which corresponds to the degree of match between the social data and a single element of the subculture model (see paragraph [0014]). For example, social data text may be matched against the n-gram models of the subculture to determine the degree to which the text expressions fit the model. In a second example, unambiguous entities mentioned in the social data may be cross-referenced to the entity lists of the subculture, resulting in a subscore. The total score, possibly normalized, indicates the degree to which the social media user “identifies” with a subculture.

Personal Entity Extraction.

Personal entity extraction 203 involves creating a set of social media contacts (e.g., Friends, Followers, etc.) for the social media user. The set of personal entities may be gathered through the friend lists and follow lists on social networks. A weighting factor for each personal entity may be determined by combining the following information:
The explicit relationship mentioned in the profile (e.g., “Brother” in the Facebook profile);
The stated relationship in social network posts (e.g., “My brother Tom is in town with his wife Alice”);
The frequency of interactions on the social network (e.g., comments by one on a picture of the other); and
The number of friends in common (if available).

The weighting factor indicates the relative likelihood that an ambiguous reference to a nickname of the personal entity is actually the entity itself. For example, if an author has 4 contacts for which “Anthony” is a valid nickname, then the prior probability that a mention of “Anthony” in a post refers to each will be proportional to the weight induced for each. Many methods may be used to produce an appropriate weighting factor. For example, a +1 score can be applied to an entity or nickname for each interaction found in social media, whereas listing as a family member can earn a +10 score; listing a spouse can earn a +30 score; and a +1 score can be given for simply being a “friend”. The score for each entity or nickname in a group may then be normalized, along with a slot for “other”, to produce a distribution over possibilities for that entity or nickname. Generally, however, a suitable method will produce a weighting that expresses the likelihood of the social media user referring to each entity, given a particular nickname mentioned. For example, a user may have three “Michael” in their social data. Michael 1 is a spouse, and has 10 interactions with the user, for a total score of 40. Michael 2 is a friend with 8 interactions, for a total score of 9. Michael 3 is a friend with no interactions, for a total score of 1. Normalizing the scores of all three Michaels, yields the following: Michael 1=0.8, Michael 2=0.18, Michael 3=0.02.

The personal entity list is treated like a special subculture to which the user belongs with maximum weight.

Personal Language Model Generation.

A user's likelihood to emit phrases (N-grams), entities, and entity groups may be modeled using a weighted combination of that person's subculture models, plus their set of personal entities. Continuing the example from paragraph [0022], if a social media user matches only 1 subculture with weight 0.5, and that subculture had the following distribution over Michael's: Michael 4=0.5, Michael 5=0.5, the mixed distribution over Michael's, given that the personal subculture has weight 1, is achieved by multiplying all priors by the subculture weight, then normalizing. Pre-normalized: Michael 1=0.8, Michael 2=0.18, Michael 3=0.02, Michael 4=0.25, Michael 5=0.25.

Although a full personal language model may be developed for each user based on this approach, in practice, however, it is not necessary to compute and store the full model for each person. The Entity Disambiguation algorithm of FIG. 4 computes only the needed elements of the model when processing each statement.

Entity Disambiguation.

Entity Disambiguation May Involve the Following Sub Processes: (1) generating candidate references+priors for each mention; (2) inferring semantic tags for each candidate reference; (3) inducing a conditional random field model; and (4) inferring a most likely assignment.

Referring to FIG. 4, entity disambiguation may involve generating a conditional random field containing: primary nodes for all mentions (ambiguous references to entities) and nodes for each concept detected in a social media conversation, conditioned on nodes representing user interests. Each primary node may contain a value for all possible reference entities for the corresponding mention. The joint probability between all primary nodes may represent the likelihood of sets of reference entities being mentioned in the same conversation.

For example, referring to the illustrative social media statement discussed above, the mention “Anthony” could have node values for the NBA player Carmelo Anthony, the user's cousin Anthony Thomas, two other sports players named Anthony, and ‘Other’. The mention ‘Bryant’ could have values for NBA player ‘Kobe Bryant, sportscaster Bryant Gumbel, clothing designer Lane Bryant, and “other.” The joint probability of Carmelo Anthony and Kobe Bryant would be high, whereas the joint for Carmelo Anthony and Lane Bryant would be low. Other factors (induced through processing social media) include the home city of the user and their interests.

Accordingly, the entity disambiguation process of FIG. 4 does not require complete specification of the joint probability table, nor does it require full probabilistic inference. Instead, the end result may be a selection of the top N most probable combinations of referenced entities, given the priors, joint, and conditional probability (ie., combinations with maximum a posteriori probability).

Preferably, the method for entity disambiguation within a social media conversation may include the following high level steps:
1. Use standard Part-of-Speech tagging methods to infer the part of speech for each word in the sentence 402.
2. Identify entity mentions using regular expressions based on words and part of speech tags. Primarily, mentions are the portions of noun phrases containing rare works or proper nouns 403.
3. For each mention, search the following sources for candidate reference entities 404:
   Crowd-sourced databases (e.g., wikipedia);
   The nickname maps for all subculture models that match the user;
   The personal entity nickname maps; and
   A special ‘other’ entity, which is a placeholder for entities not covered by the models. (The weight of this entity is based on the relative commonness of the nickname; ‘Michael’ has a large weight for ‘other’, whereas ‘Netanyahu’ has a small weight)
4. Compute a prior probability over all possible reference entities for each mention. The prior for each candidate is the likelihood within its subculture (or personal entity list) multiplied by the weight of the subculture.
5. Revise priors by propagating influences from the conditional variables 407. Conditional variables are included based on semantic connections between the user's profile and interests and the referenced entities 406. For example, Carmelo Anthony plays for the New York Knicks, based near New York City. If the user lives in this area, it increases the likelihood that he would mention Carmelo Anthony.
6. Search for N most probable combinations of referenced entities using heuristic search 408. The joint probability of a set of referenced entities (independent of priors and conditional variables) is based on the concept of co-occurrence surprise, defined below. Roughly, the measure, which is strongly related to the common concept of co-occurrence, indicates the level of surprise one would feel in hearing all of the referenced entities in the same conversation. The joint probability is combined with the refined priors to produce a final score for a particular combination of referenced entities.
7. Define confidence measure for each referenced entity found in the top N combinations 409. In the example above, if the Kobe Bryant/Carmelo Anthony combination has a far greater score than other combinations, both referenced entities would receive a high confidence score, which is important during the later step of Evidence Aggregation.
8. If high confidence 410, report to the rest of the algorithm that user has referred to entities in the best combination 411. Othenvise, report nothing 412.

Given an infinitely large corpus, multiple conversations containing every possible combination of entities would be present. It would be possible to compute the co-occurrence frequency of all combinations. Defining the joint probability over any set of mentions and corresponding referenced entities would be tedious, but straightforward. In the absence of this theoretical (i.e., infinitely large) corpus, however, the joint probability over any set of mentions and corresponding referenced entities may be approximated using the semantic network that connects any pair of entities. FIG. 4a illustrates the conceptual approach of the approximated model for determining the joint probability field.

Referring to FIG. 5, the nodes of the semantic network may represent classes of entities (e.g., “sports” represents all teams, players, coaches, etc related to sports). The value for each node may indicate the likelihood that if two entities in that class are picked at random, someone, somewhere has mentioned them both in the same conversation. For example, in a category as wide as sports, the value may be very low, but not infinitesimal. Similarly, for the category ‘object’, the value may be infinitesimal. By contrast, for a category ‘current los angeles lakers players’, the value may be very high, near 1.

Additionally, the edges of the semantic network may connect semantic objects to more specific semantic objects. For example, sports may have a link pointing to basketball, basketball may have a link that points to NBA Basketball, etc 501. The network, therefore, may be a directed acyclic graph rooted at the most general node (e.g., ‘object’).

More particularly, FIG. 5 shows a semantic sub-network for the example conversation “I love watching anthony and bryant fight it out.” The sub-network shows two of the three mentions in this example, “bryant” and “anthony” 504. For the “bryant” mention, two candidates are shown, which may be drawn from crowd-sourced databases and the subculture models: sportscaster Bryant Gumbel and NBA basketball player Kobe Bryant 503. Each candidate entity node is connected to the semantic nodes that are pulled from the crowd-sourced DB and the subculture models. These are the links between the automated entity discovery and the semantic models which may be generated manually.

As shown in FIG. 5, there are two possible combinations of entities: (1) Carmelo and Kobe, and (2) Carmelo and Gumbel. Both are plausible combinations, but (1) is by far the most likely, based on the semantic connections of each and the associated co-occurrence surprise values. More particularly, the co-occurrence surprise value may be computed by the following method:
1. For each entity, find all connections to the semantic network (e.g., Kobe Bryant is connected to ‘current los angeles lakers players’ and possibly others).
2. For all pairs of ‘leaf’ semantic objects, find all paths between them.
3. For each path, the path co-occurrence surprise is the value on the most specific ancestor of both leaf semantic objects.
4. To combine multiple path co-occurrence surprise values, we treat each path as independent likelihoods of co-occurrence, and combine according to standard probability theory. The calculation uses the inverse co-occurrence surprise, which is 1 minus the co-occurrence surprise value. Specifically, the net inverse co-occurrence surprise value for multiple paths is the product of the inverse co-occurrence surprise values for each path. The net co-occurrence surprise value is therefore 1 minus this value. For any two entities a and b, with N paths between them, the individual path values, cs1 through csN, and be combined as follows:

CS_{a,b}=1−product_{{i=1,2, . . . ,n}}(1−cs_{a,b}ⁱ)

As an ad hoc method for combining this semantic data with real corpus data, pairs of entities with actual co-occurrence frequencies will be given a value between 1.0 and 2.0. One method is to normalize all frequency data to a 0 to 1 range; the total value is then 1 added to the normalized value.

FIG. 6 depicts the semantic paths and co-occurrence surprise values which connect entity combination 1 (Carmelo and Kobe) in the semantic network of FIG. 5. For entity combination 1 (Carmelo and Kobe) 505 there are two semantic paths between the two entities. The first semantic path 507 is rooted at the NBA node, whose co-occurrence surprise value of 0.1 means there is only a 10% chance that two randomly picked NBA entities would be mentioned in a single conversation. The second semantic path 508 is rooted at “Current All Star NBA players,” a very small semantic category for which many conversations occur. Thus, the likelihood of two entities in that category being discussed together is extremely high: 0.991.

By contrast, referring to FIG. 7, the only semantic path between the entity combination 2, (Bryant Gumbel and Carmelo Anthony) 506 is rooted in ‘sports’, with a co-occurrence surprise value of 0.001. Accordingly, the disambiguation process of FIG. 4, would report to the rest of the algorithm that the user has referred to Carmelo Anthony and Kobe Bryant as entities in the best combination.

Additionally, the semantic network may be amended at any time by adding paths. For example, if we learn that Bryant Gumbel and Carmelo Anthony are both alumni of the same university, an additional path can be added to FIG. 5 to represent this. Furthermore, some paths may be subculture dependent, and therefore may be weighted by the subculture match score for the author to reflect this relationship. For example, the only people who would likely know that Carmelo and Gumbel attended the same university are others who attended that university.

Sentiment Analysis.

For many purposes, including suggesting items relevant to the author, it may be useful to know how the author feels about the subjects the author is discussing. Generally, Targeted Sentiment analysis (TS analysis) takes as input
1. A conversation; and
2. A set of mentions in the conversation, which refer to entities.
   For each mention, the TS analysis produces a rating that indicates the author's sentiment. In a preferred embodiment, a positive rating indicates a positive sentiment, a negative rating indicates negative sentiment, and a zero rating indicates no sentiment. The magnitude expresses the strength of the sentiment. The rating may be normalized to the range [−1,1].

In addition to the rating, a confidence measure may be output for each mention, which indicates the certainty of the system for its rating. The confidence measure may range from [0,1]. For example, “I'd rather not watch the movie Titanic again” indicates a slightly negative sentiment, −0.2 with medium confidence 0.4. “I LOVE the movie Titanic” is strongly positive, 0.99, with strong confidence, 0.7. If the user is known to rarely use sarcasm, the confidence may be higher.

In a preferred embodiment, sentiment analysis may include targeted word-based analysis methods as follows:
1. Prior to analysis, construct a model that maps individual words to valences. For example, “hate=−4”, “love=5”, “disappointing=−2”, “solid=1”, etc.
2. Analysis begins by looking up the valence for each word in a conversation
3. For each mention, sum the valence of each word in the conversation, discounting each valence by the distance between the word and the mention.
4. Output the sum as the rating.

Additionally, the following targeted word-based analysis method may be added:
1. Custom valence models, each specific to a subculture. For example, “wicked” is highly negative in some subcultures, but positive in others.
2. Discounting based on clause groupings and filler phrases, in addition to distance. In the example, “The best, in my opinion, is Maiming”, ‘in my opinion’ is not counted in the distance between ‘best’ and ‘Manning’.
3. Confidence measures may be generated using the ratio of the discounted valence sum to the ratio of the sum of the absolute values of the undiscounted valences. This measure gives highest confidence when all valence words are the same sign and close to the mention.

Additionally, pattern based targeted sentiment analysis may be used to define zero or more subculture-specific linguistic patterns that indicate sentiment. For example, “Go Raiders” is a highly positive statement about a professional football team. The pattern [“Go”] ENTITY is a sports-specific pattern that works across multiple teams and sports, and can be interpreted as positive with very high confidence. Generally, patterns may be implemented as regular expressions over the following items:
1. Specific words or word sets (e.g., Go, Yeah, Get'em, Long live the);
2. Parts of speech (e.g., adjective, verb, preposition);
3. Multi-word clauses;
4. The special ENTITY tag; and
5. Wildcards indicating any word or part-of-speech (e.g., [0,2] indicates 0 to 2 filler words).
   Thus, a pattern may include a regular expression, a rating, and a confidence value. If an author's conversation matches a pattern for a particular mention, then the rating and confidence are returned for the mention.

An exemplary overall targeted sentiment analysis algorithm is as follows.
1. Execute part-of-speech tagging for the conversation
2. Extract the locations of all mentions in the conversation
3. For each mention
   a. Replace mention with special ENTITY tag
   b. Check for matching patterns.
      i. If matches, return the match with the highest absolute value.
      ii. If no matches, perform standard word-based analysis and return result.

Evidence aggregation 210: Multiple conversations by a given social media user may reference a given entity. In these cases, the disambiguation algorithm above will produce qualitatively similar assertions, but with different sentiment values and confidence levels. A method may be supplied to unify these sentiment values and confidence levels into a single sentiment value and confidence level for that entity.

One method is to simply average sentiment values and confidence levels. Another method may assume that the existence of other mentions for an entity inherently raises the confidence for that entity. Intuitively, if a person mentions an entity once, they are more likely to mention that same entity again. For example, if one conversation leads to the inference fan.CarmeloAnthony=0.7(0.4 confidence) and another conversation leads to fan.CarmeloAnthony=0.8(0.5 confidence), the sentiment level can average to 0.75 and the confidence can combined as follows: confidence=1−(1−0.4)*(1−0.5)=0.7. A third method may include the degree of disagreement in sentiment levels. The confidence may be reduced by function of the difference in sentiment levels. For example, for inferences fan.CarmeloAnthony=0.7(0.8 confidence) and fan.CarmeloAnthony=−0.2(0.8 confidence). The original computed confidence can be multiplied by (2−abs(0.7−0.2))/2=1.1/2=0.65. With no difference in confidence, the original computed confidence remains the same. With maximum difference, confidence becomes 0.

A second iteration of subculture identification may be performed. After inferring entities mentioned, overall accuracy may be improved if the weighted set of subcultures is recalculated based on the inferred entities. For example, if the basketball subculture is detected with a small weight (e.g., 0.3) upon initial analysis, but the social media user mentions 10 NBA players in conversations, the weight of the basketball culture should be revised upward. This revision, however, may trigger a re-analysis of the conversations, and would impact results. A discount may be applied on subsequent iterations to prevent continuous processing and to promote a convergence of subculture weights.

Referring to FIG. 12, exemplary hardware 66 for implementing the system may include an administrator computer 68, a Level 2 application server 70 connected to the administrator computer and the internet, a Level 3 database server 72, and a SQL Query storage server 74. The administrator computer may be Intel-based running Windows 7 operating system with CPU, main storage, I/O resources, and a user interface including a manually operated keyboard and mouse. The application, database, and storage servers, respectively, may be an Intel-based server running Linux operating system. The application server 68 may be connected to Level 1 clients 76 via the Internet and/or other network(s).

The social media understanding system 100 may stand alone or may be part of another system. For example, the social media understanding system 100 may be part of a social media marketing system which collects communications exchanged by users of an Internet based social media community, generates a collection of purchase decision profiles for each of those users, researches market conditions for a set of goods and services, and transforms these data into individually customized offers to buy or sell goods and services to those users and their social network contacts. A social marketing system is disclosed in commonly owned, co-pending patent application Ser. No. 13/761,121, entitled, “Apparatus, System, and Methods for Marketing Targeted Products to Users of Social Media,” filed on Feb. 6, 2013, (the '121 patent application). The '121 patent application is incorporated herein by reference in its entirety.

In a second example, the social media understanding system 100 may be part of a system that predicts or analyzes world events based on social media. For example, if many users of the system abruptly begin discussing common entities within a subculture, it may indicate that an important event has happened or will happen related to that entity. This may have great value where social media is the only media source accurately covering the subculture.

While it has been illustrated and described what at present are considered to be preferred embodiments of the present invention, it will be understood by those skilled in the art that various changes and modifications may be made, and equivalents may be substituted for elements thereof without departing from the true scope of the invention. Additionally, features and/or elements from any embodiment may be used singly or in combination with other embodiments. Therefore, it is intended that this invention not be limited to the particular embodiments disclosed herein, but that the invention include all embodiments within the scope and the spirit of the present invention.

What is claimed is:

1. A computer-implemented method performed by a processor for understanding a snapshot of social network information, the method comprising:
accessing social network information associated with a user of social media;
collecting a snapshot of social network information associated with the user which comprises a plurality of social media statements;
accessing a plurality of subculture models;
analyzing the snapshot of social network information and the plurality of subculture models to identify a weighted set of subcultures that reflects interests of the user;
analyzing the snapshot of social network information to identify one or more contacts associated with the user;
assigning a weight to each contact that reflects the strength of each contact's connection to the user;
generating a personalized language model for the user that is based on the weighted set of subcultures and the set of contacts associated with the user, and which comprises an entity list;
extracting at least one mention of entities that are identified on the entity list from the plurality of social media statements;
compiling a list of possible references for the at least one mention of entities extracted from the plurality of social media statements;
inferring a weighted posterior distribution over the list of possible references for the at least one mention of entities that are identified on the entity list; and
analyzing the weighted posterior distribution to identify a list of disambiguated references for the at least one mention of entities in the snapshot of social network information.

2. The computer-implemented method of claim 1, further comprising rating the user's sentiment for the list of disambiguated references and recording the user's sentiment for the list of disambiguated references in a database of inferred user profile opinions.

3. The computer-implemented method of claim 2, wherein rating the user's sentiment for the list of disambiguated references comprises word-based targeted sentiment analysis and pattern-based targeted sentiment analysis.

4. The computer-implemented method of claim 3, wherein the pattern-based targeted sentiment analysis comprises comparing at least one of the user's plurality of social media statements with a pattern of expressions.

5. The computer-implemented method of claim 4, wherein the pattern of expressions comprises a regular expression, a rating, and a confidence value.

6. The computer-implemented method of claim 1, further comprising inferring an updated weighted set of subcultures that reflect interests of the user based on an analysis of the snapshot of social media and the list of disambiguated references.

7. The computer-implemented method of claim 6, further comprising recording the updated weighted set of subcultures that reflect interests of the user in a database of inferred user profile interests.

8. The computer-implemented method of claim 1, further comprising recording the updated weighted set of subcultures that reflect interests of the user in a database of inferred user profile interests.

9. The computer-implemented method of claim 1, wherein the plurality of subculture models each comprise a database of subculture specific entities and a database of subculture specific entity nicknames

10. The computer-implemented method of claim 9, wherein each of the plurality of subculture models further comprise a database of subculture specific sentiment patterns.

11. The computer-implemented method of claim 10, wherein each of the plurality of subculture models further comprise a database of subculture specific semantic graph connections.

12. The computer-implemented method of claim 11, wherein each of the plurality of subculture models further comprise a database of subculture specific semantic graph connections.

13. The computer-implemented method of claim 12, wherein each of the plurality of subculture models further comprise a database of subculture specific weighted N-grams.

14. The computer-implemented method of claim 13, wherein each of the plurality of subculture models further comprise a database of subculture specific co-occurrence frequencies.

15. The computer-implemented method of claim 1, wherein generating the personalized language model for the user comprises modeling the user's likelihood to emit specific N-gram expressions and refer to a particular entities.

16. A program storage device readable by a machine tangibly embodying a program of instructions executable by a machine to perform method steps for understanding a snapshot of social network information, the method steps comprising:
accessing social network information associated with a user of social media;
collecting a snapshot of social network information associated with the user, which comprises a plurality of social media statements;
accessing a plurality of subculture models;
analyzing the snapshot of social network information and the plurality of subculture models to identify a weighted set of subcultures that reflect interests of the user;
analyzing the snapshot of social network information to identify one or more contacts associated with the user;
assigning a weight to each contact that reflects the strength of each contact's connection to the user;
generating a personalized language model for the user that is based on the weighted set of subcultures and the set of contacts associated with the user, and which comprises an entity list;
extracting at least one mention of entities that are identified on the entity list from the plurality of social media statements;
compiling a list of possible references for the at least one mention of entities extracted from the plurality of social media statements;
inferring a weighted posterior distribution over the list of possible references for the at least one mention of entities that are identified on the entity list; and
analyzing the weighted posterior distribution to identify a list of disambiguated references for the at least one mention of entities in the snapshot of social network information.

17. A computer program product recorded in a computer storage medium for understanding a snapshot of social network information comprising:
first program instructions for accessing social network information associated with a user of social media;
second program instructions for collecting a snapshot of social network information associated with the user, which comprises a plurality of social media statements;
third program instructions for accessing a plurality of subculture models;
fourth program instructions for analyzing the snapshot of social network information and the plurality of subculture models to identify a weighted set of subcultures that reflect interests of the user;
fifth program instructions for analyzing the snapshot of social network information to identify one or more contacts associated with the user;
sixth program instructions for assigning a weight to each contact that reflects the strength of each contact's connection to the user;
seventh program instructions for generating a personalized language model for the user that is based on the weighted set of subcultures and the set of contacts associated with the user, and which comprises an entity list;
eighth program instructions for extracting at least one mention of entities that are identified on the entity list from the plurality of social media statements;
ninth program instructions for compiling a list of possible references for the at least one mention of entities extracted from the plurality of social media statements;
tenth program instructions for inferring a weighted posterior distribution over the list of possible references for the at least one mention of entities that are identified on the entity list; and
eleventh program instructions for analyzing the weighted posterior distribution to identify a list of disambiguated references for the at least one mention of entities in the snapshot of social network information.
